(19) United States
(12) Patent Application Publication
(10) Pub. No.: US 2021/0192247 A1
(43) Pub. Date: Jun. 24, 2021

(54) SYSTEMS AND METHODS FOR ELECTRONICALLY IDENTIFYING PLANT SPECIES

(71) Applicant: PlantSnap, Inc., Telluride, CO (US)

(72) Inventor: Eric Ralls, Telluride, CO (US)

(21) Appl. No.: 17/191,170

(22) Filed: Mar. 3, 2021

Related U.S. Application Data
(63) Continuation of application No. 15/973,660, filed on May 8, 2018.
(60) Provisional application No. 62/503,068, filed on May 8, 2017.

(51) Int. Cl. G06K 9/00; G06K 9/62; G06K 9/22; G06F 16/51; G06F 16/583

(52) U.S. Cl. CPC G06K 9/00979; G06K 9/6256; G06K 9/22; G06F 16/51; G06N 20/00; G06K 9/00671; G06K 9/6277; G06K 9/6254; G06F 16/5838

(57) ABSTRACT

A system is described herein comprising an application running on a processor of a mobile device, the application receiving a query image, wherein the application is communicatively coupled with one or more applications running on at least one processor of at least one remote server. The system includes the application providing the query image to the one or more applications, the one or more applications processing the query image to identify a query type corresponding to the query image, wherein the query type comprises a plurality of species. The system includes using a query type recognition engine corresponding to the query type to process the query image, the processing the query image including identifying at least one species corresponding to the query image. The system includes the one or more applications providing information of the at least one species to the application, wherein the application displays the information.

### RELATED APPLICATIONS

This application claims the benefit of U.S. App. No. 62/503,068, filed May 8, 2017.

### TECHNICAL FIELD

The disclosure herein involves an electronic platform for identifying plant species.

### BACKGROUND

There is an overwhelming number of plant species on the earth from the most exotic locations to backyard environments. Often, hikers, climbers, backpackers, and gardener's may encounter unknown plant species. There is a need to facilitate identification using a convenient electronic platform when circumstances prevent identification through conventional methods.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 show a point of entry for images into the Plantsnap environment and image processing workflow, under an embodiment.

FIG. 2 shows a method for data collection and processing, under an embodiment.

FIG. 3 shows image capture and processing workflow, under an embodiment.

FIG. 4 shows a screen shot of an application interface, under an embodiment.

FIG. 5 shows a screen shot of an application interface, under an embodiment.

FIG. 6 shows a screen shot of an application interface, under an embodiment.

FIG. 7 shows a screen shot of an application interface, under an embodiment.

FIG. 8 shows a screen shot of an application interface, under an embodiment.

FIG. 9 shows a screen shot of an application interface, under an embodiment.

FIG. 10 shows a screen shot demonstrating an image recognition model, under an embodiment.

FIG. 11 shows a system for processing an image, under an embodiment.

### DETAILED DESCRIPTION

A platform is described herein that electronically identifies plant species using images captured by a mobile computing device. This disclosure explains the functions performed by an application, i.e. the Plantsnap application, along with the necessary backend functions needed to support these functions. The application enables users to perform a variety of functions that facilitate identification of plant species, learning about plants, and communicating with others, and sharing information with a community. The Plantsnap application and backend services may be referred to as the Plantsnap application, the application, the Plantsnap platform, and/or the platform.

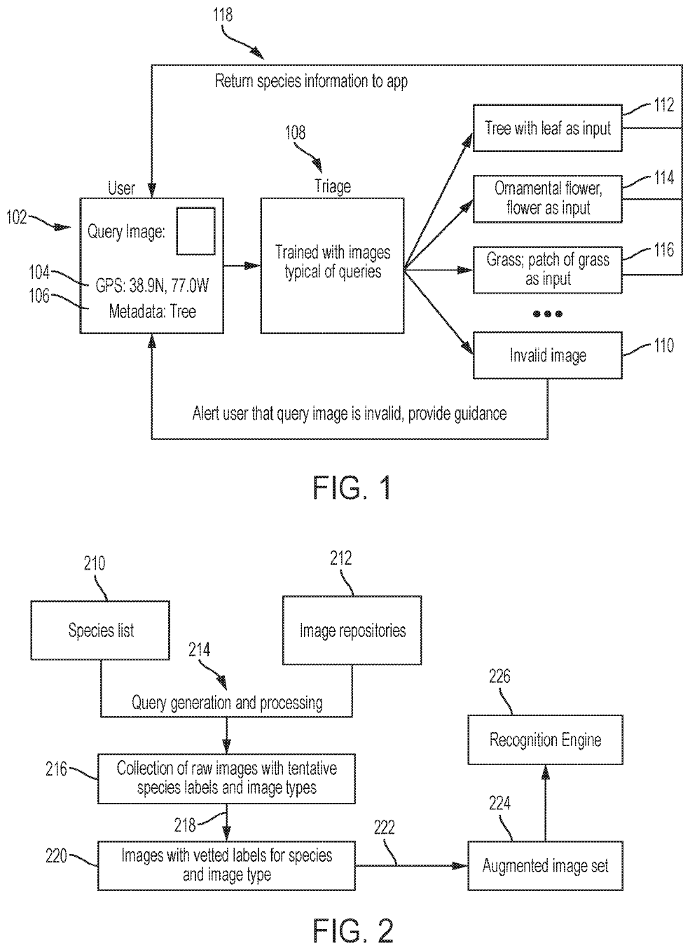

FIG. 1 shows a workflow of the Plantsnap application under one embodiment. The user of the application queries the Plantsnap system with an image, GPS and metadata. Rather, the user may snap a photo of a plant using a smartphone or other mobile device running the Plantsnap application. The smartphone reports the GPS coordinates of the image and metadata. Metadata is collected by the smartphone GPS and may also be reported by users through commentary or other input. The query is passed to a triage recognition engine, which directs the query to a specialized recognition engine suitable for this query. Systems and methods for implementing this specialized recognition are disclosed herein.

### 1. Visual Recognition

The application assists the user in making queries that help identify a plant's species.

a. Image-based queries: The user may be able to take a photograph of some part of a plant to use as a search key. The application's interface guides the user to take appropriate photographs. Photographs may contain a single leaf, a close-up image of a flower, or a close-up image of a whole plant, if the plant is small.

b. GPS: In addition, users enable GPS services under an embodiment; user location may be used to filter responses.

c. Additional Metadata: The user may also enter some basic information about the plant through a menu interface. For example, is this a tree, a bush, or a flower?

d. Responses: The application responds with an ordered list of the top matching plant species. The Plantsnap application may include some level of confidence associated with each response. Each response is under an embodiment linked to additional data about the species (see below).

### 2. Plant Information

For each species in the application, the user is provided with image and text information. The images should illustrate the appearance of different features of the plant, such as its leaves, bark, flowers and fruit. The text may include descriptions of the appearance of the plant, its geographic locations, and its uses. The application may also include hyperlinks to external sites. These may include sites such as Wikipedia. The application could also include links to local stores where these plants, or plant care products, are available for purchase.

### 3. Browsing

The application provides under an embodiment a mechanism for searching species by name, or browsing through a particular subset of the species in the application (e.g., trees, ornamental flowers, vegetables).

### 4. Collection

The user is able to create under an embodiment a personal collection of images. This allows reference to images taken before, along with any notations and GPS locations indicating where the images were taken.

### 5. Communication

a. Labeling: The application provides under an embodiment a mechanism that allows users to label the species of a plant. These labels may be associated with a user's personal collection, and uploaded to the Plantsnap dataset, allowing the platform to acquire additional training data.

b. Posting and answering questions: Users should be able to post their questions to other users, and chat with users to assist in identification.

c. Posting Collections: Users should be able to post their collections with GPS locations, allowing others to make use of their identifications.

### 6. Scope of Dataset

The Plantsnap application covers under one embodiment between one thousand and several thousand species of plants in the Continental US, excluding tropical regions such as southern Florida. One embodiment covers species across the world. As one example, an embodiment may cover 250,000 across the world. One embodiment includes 350,000 across the world. These species may be selected based on their importance (how common they are and how much do people care about them) with a bias towards plants that are easier to identify visually. These species of plants are grouped into a few classes, allowing construction of a separate recognition engine for each class. These classes might include trees, ornamental flowers, weeds, and common backyard plants. The scope of the dataset is under one embodiment determined with input from professional botanists.

Under another embodiment, the application extends coverage to handle all species of interest in this geographic region. The application may exclude species that are very rare and that are not of interest to most users (e.g., moss), or that are difficult to identify properly from images. The application interface and workflows clearly explain to the user what is not covered, so that a user understands the scope of the Plantsnap application capabilities.

### 7. Gaming

The application may contain games aimed at educating users about nature and the world around them. These games may run purely on a phone, such as games in which the user is shown several leaves or flowers and asked to identify them. Or the application may include gamification as part of the Plantsnap application. This involves under one embodiment collecting games, in which users compete to collect images of the 20 most common trees in their neighborhood. An alternative embodiment includes a system of points, earned for prestige, that reflect how many species a user has collected, or that credits users for helping to identify plants that other users have collected. Such games make the application more appealing for classroom use and foster a network of users.

### 8. Performance:

a. Speed: Images taken in the application are uploaded to a central server. This upload represents the primary bottleneck on system performance under an embodiment; computation time on the server should be negligible.

b. Accessibility: The application is not under one embodiment able to perform recognition without network connectivity under one embodiment. Other functions, such as browsing species or referring to one's collection should be unimpaired by a lack of connectivity.

c. Accuracy: A chief measure of accuracy is how often the application places the correct species either at the top or in the top five of its responses. Success may increase for carefully taken queries; performance in the field by ordinary users may be lower.

### 9. Platforms

The application runs on multiple mobile computing operating systems including iOS or Android. Users may also interact with the Plantsnap application through a web interface.

### Customized Versions of the Application

One embodiment of the application may create a version of the application for classroom use that contains only common plants found in a local region. Versions of the application may be created for each National Park. The application may also provide the ability for users to create their own versions of the Plantsnap platform. This may allow a middle school class, for example, to create a version of the application containing plants that the students identified themselves, illustrated with images that the students have taken.

### 1. Triage

Under one embodiment, an image is fed into a recognition engine that determines the type of image that the user has uploaded. Possible image types may include: “leaf”, “flower”, “whole plant”, or “invalid”. The image determines which recognition engine may be used to determine species. If an image is judged to be invalid, the user is alerted. The application may then guide/instruct the user to take better images.

### 2. Species ID

Each species identification classifier is tuned under an embodiment to a particular class of plants and a particular type of input. In an initial release, we expect that this includes engines for:

a. Trees, using images of isolated leaves as input.

b. Ornamental flowers, using an image of the flower as input.

c. Bush and shrubs, using an image of a leaf as input.

d. Common backyard plants (e.g., basil, tomato plants, ferns, hosta, poison ivy, weeds) using a close-up picture of the whole plant.

e. Grass, using a picture of a patch of grass.

Alternative embodiments may allow users to enter queries using multiple pictures. For example, a user may submit a picture of a leaf and a second picture of bark, when attempting to identify a tree.

The application may under an embodiment provide different recognition engines for different geographic regions. For example, by creating different engines for the trees of the Eastern US and for the trees of the Western US Plantsnap is able to improve species identification.

The key to achieving high recognition rates is in constructing appropriate data sets to use in training. A third party image recognition platform creates recognition engines based on the data sets that we provide, and so our primary effort in creating these engines will be to create these data sets.

### Data Collection and Processing

A variety of different image datasets are created to support Plantsnap. These image datasets include:

### 1. Query Datasets.

These contain images that resemble the images that users may submit when querying the system. So, for example, if we want a recognition engine to be able to identify a red maple from an image of its leaf, we will need images of isolated leaves from red maple trees that capture the variation we expect to see both in the leaves themselves, and in the imaging conditions. On the order of 300 images per species and query type are required under one embodiment (e.g. 300 images of leaves from red maple trees for this example).

### 2. Augmented Query Datasets.

It is difficult to capture the entire variability of the picture-taking process through images found on the web. One embodiment of the Plantsnap backend database creation significantly improves the robustness and accuracy of the recognition engines by processing real images to generate new images that may resemble images that users might take, but that are not available through any above referenced image capture process. As a simple example, given an image of a plant, an embodiment of the database creation process may rotate the image a bit, or create different cropped versions of the image, to mimic the images that would have been taken had a user's camera position or angle been slightly different. Given images of leaves on plain backgrounds, a method of new image creation may segment the leaf and superimpose it on images of a variety of common backgrounds, such as sidewalks or dirt. This may improve the ability to recognize such images when they are submitted.

### 3. User Images.

As users upload and tag images the Plantsnap application is able to make use of these images to improve the platform. Most importantly, user uploads provide many real-world examples of images, identified by species. These images may be used to retrain the recognition engines and improve performance. These images may also provide the platform with more up-to-date information on the geographical distribution of plant species. User images may also provide us with examples of invalid images, which are described next.

### 4. Examples of Invalid Images.

To identify images that users may submit that are not suitable for identification, examples of such inappropriate images are used under an embodiment. Initially, these are sampled from random images that do not depict plants. Once the application is deployed, unsuitable image detection may be improved by finding inappropriate images submitted by users.

### 5. Illustrative Images.

Under an embodiment images that may not be suitable for recognition, may nevertheless inform the user as to the appearance of each plant. A recognition engine may under an embodiment identify tree species using images of isolated leaves. The application may augment the results by showing users images of whole trees, or other parts of the tree (bark, flowers, fruit).

The creation and maintenance of datasets may require several steps and may be facilitated by a number of automated tools.

### 1. Identification of Species and Image Types.

In consultation with botanists, a list of species is identified for inclusion in the initial release. For each species, an embodiment of the application identifies the type of image that will be used to identify the plant.

### 2. Harvesting Raw Images.

Some of the appropriate images may come from curated datasets (e.g., USDA, Encyclopedia of Life). Others may be found through image searches (eg., Google™ or flickr™).

### 3. Filtering and Metadata.

Images found in step 2 may already be associated with some species information. However, this species information may or may not be reliable, depending on the source. Many images may be wholly unsuitable. For example, Googling “rose” may turn up drawings of a rose. In addition to the species, though, we must identify the type of each image. Does it show an isolated leaf, a flower, a whole plant?

Some of this filtering can be done with the assistance of automation. For example, a triage engine, designed to find invalid images, may also determine that some images downloaded from flickr™ are invalid. Images may be automatically or manually identified as invalid. Tools may be developed to determine the type of each image. These tools are not perfect, but may provide useful initial classifications. Additional metadata may be provided by workers on Amazon's Mechanical Turk, as needed, e.g. common name, species name, habitat, scientific nomenclature, etc.

FIG. 1 show a point of entry for images into the Plantsnap environment. A user uses the camera of a smartphone under an embodiment to capture or “query” an image 102. The GPS functionality of the smartphone associates GPS location coordinates 104 of the user with image. Under the example of FIG. 1, the user queries an image at location GPS: 38.9N, 77.0W. The user may also provide metadata information 106. For example, the user specifies that the image is a tree. The Plantsnap application then passes the image to a remote server running one or more applications, i.e. a Triage recognition unit, for identifying the image 108. As further described herein, the triage recognition unit is trained with images typical of queries and with invalid images. If the Triage recognition unit identifies an invalid image, the recognition unit transmits the information to the application 112 which notifies the user via the application interface. The recognition unit may identify a tree using a leaf image as input 114. The recognition unit may identify an ornamental flower using a flower image as input. The recognition unit may identify grass using a patch of grass as input 116. The triage recognition unit then returns the identification information 118, i.e. the identified species, to the application which then which notifies the user via the application interface.

FIG. 2 shows a method for data collection and processing. The method includes compiling a species list 210 produced with assistance from botanists. Images of species included in the list may be obtained through image repositories 212, i.e. images may be harvested from curated datasets (e.g., USDA, Encyclopedia of Life). Others may be found through image searches (eg., Google™, flickr™, and Shutterstock™). Query generation and processing 214 produces a collection of raw images with tentative species labels and image types 216. The method then implements 218 quality control of species ids and image types using recognition engines and Mturk workers. The method produces 220 images that are labeled for species and image type. The method uses 222 computer vision and image processing algorithms to generate a larger image set with greater variation. Computer vision tasks include methods for acquiring, processing, analyzing and understanding digital images, and extraction of high-dimensional data from the real world in order to produce numerical or symbolic information, e.g., in the forms of decisions. The method therefore produces an augmented data set 224. The method then uses an image recognition platform to build the recognition engine 226.

The image recognition platform comprises computer models trained on a list of possible outputs (tags) to apply to any input. Using machine learning, a process which enables a computer to learn from data and draw its own conclusions, the image recognition models are able to automatically identify the correct tags for any given image or video. These models are then made easily accessible through a simple API.

The Plantsnap platform includes a database of plants subject to identification. The database includes the following columns: DataBase Name, Scientific Name of Plant, Genus Name and Species Name, Scientific Names Lookup With Already Processed Name, Common Name of Plant, Common Name Lookup With Processed Names, and Comment.

The present disclosure relates to an application for identifying plants preferably utilized with Smart Phones which allows a user to take at least one image of a plant such as a tree, grass, flower or a plant portion. The application and backend services compare the image(s) to a database of at least one of images, models and/or date and then provide identifying information to the user related to the plant.

Shazam™ is a downloadable application which can be downloaded on the iPhone or other Smart Phone which allows a user to utilize a microphone to “listen” to a song as it is being played. A processor then identifies a song correlating to the played song, if possible, based on comparison to a database of entries. This allows users to identify songs and/or then provide information about specific songs.

As another example, Google™ provides an application allowing users to take a picture of a famous landmark. The application then compares that picture to information in a database to identify that landmark and provide information about it.

There is a need for improved methods of identifying plant genus and species. Identification of plant species presents unique difficulties. In contrast to landmarks, plant form and shape are variable over time for individual plants and across plants belonging to the same species. Accordingly, a need exists for an improved application for identifying plants.

An embodiment described herein uses a smartphone camera to capture a plant image and to provide the image to an application and backend services for identification. The application and backend services identify the plant based on a comparison of the image with database images, models and data associated with known plants. The application compares the image(s) to database entries in an effort to accurately estimate the type of plant being investigated by the user and then provide information relative thereto.

Under an embodiment a mobile device application is provided. The mobile device comprises a camera. Mobile devices include the iPhone™ and various Android™ based phones available on the market as well as Blackberry™ and other devices. These devices comprise a camera to capture either still or moving images.

A user may take a still image, if not a video image, of a particular plant or portion thereof. A processor of an application or backend remote server application compares the image(s) to database entries and then determines which of the models, images and/or preloaded information the images most closely resemble. An output is then provided which identifies at least one if not a plurality of options which most closely resemble the image, while providing information about the plant(s) such as the name of the plant, flower, grass, tree, shrub or other plant or portion thereof.

The application may be configured to orient the image relative to stored images in the database and/or orient database entries to attempt to match the captured image(s) so that the captured image or images could be compared to those maintained by the system. Each of the image or images may be analyzed relative to stored images, models and/or date under similar or dissimilar perspectives depending upon the embodiment employed. When analyzing the taken images relative to database entries, the processor of the application or backend remote server applications typically search/analyze database entries for patterns and/or numerical data related to the pixel data of the captured image and/or other features.

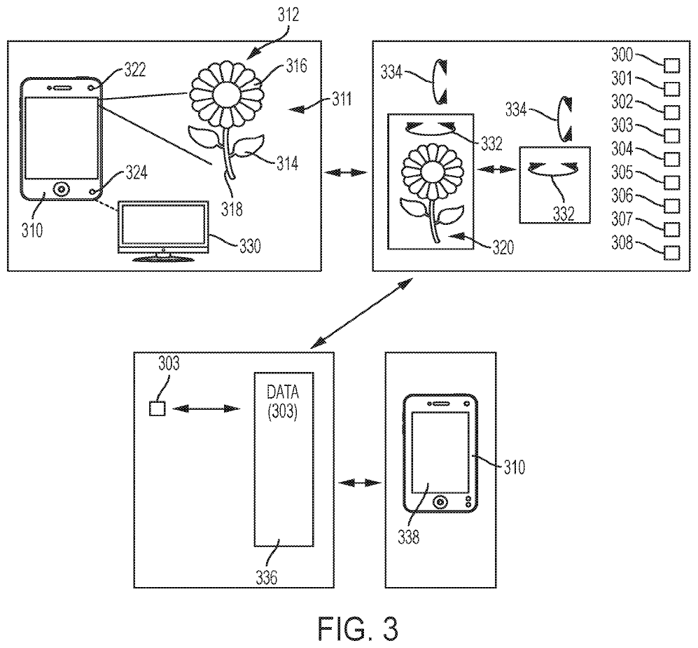

Utilizing different landmarks such as the relative lengths and width of leaves, differing relationships to stalks and/or other components, particularly when combined with color, an embodiment may provide a plant recognition software for various uses. Such uses may include allowing a clerk at a nursery to identify a particular plant at a checkout for appropriate pricing. FIG. 3 shows a smartphone 310 capturing the image of plant or a portion of a plant such as, in this case, a plant portion 312 having two leaves 314, a flower 316 and a stalk 318. The smartphone 310 has a camera 322 which is capable of capturing at least one of still or moving images. After obtaining one of an image 320 or series of images such as in the form of a video with the Smart Phone 310 and/or a camera such as camera 322 connected to a processor such as internal processor 324 (which could alternatively be an external processor such as a computer 330), the image or series of images can then be compared to a series of database entries such as images, models and/or information by at least one of the processors 324, 330. Camera 322 need not be integrated into Smart Phone 310 for all embodiments.

It is possible that each of the database images 300-308 are images, models, or data of existing plants or plant portions possibly having a three-dimensional effect so that either one of the image 320 or series of images can be rotated either in the left or right direction 332 as shown in the figure and/or rotated in the front to back direction 334 so that the image 320 could be manipulated relative to the database entry, such as test image 303.

It is more likely that instead of rotating image 320, that the image 303 is actually a three dimensionally rendering model which could possibly be based on images originally obtained and stored and can now be rotated in directions 332 and 334 so as to attempt to match the orientation of image 320. A match of orientation might be made as closely as possible. Calculations could be made to ascertain the likelihood of the image 320 being represented by the data behind model 303. The process could repeated for models 300-308 (or what is expected to be a large number of images, models and/or data) for a particular image(s) 320.

It may be that data could be entered into the smartphone 310 such as “flower” so that only flower images are used in the identification process. It may also be possible to enter “leaf” so that that only leaves are compared. Alternatively, it may be that subsets of images may be identified for comparison using information derived from image 320. It may also be possible for multiple entries 300-308 to be the same plant, but possibly having at least slightly different characteristics, such as older, younger, newly budding, different variations, different seasons, etc.

Furthermore, it may be that the processor 324, 330 can make a determination as to likely representation of the image 320 as to being a flower, leaf, stem, etc., and then preferentially compare image 320 to a subset of database images. If the likelihood of the match exceeds a predetermined value, then a match may be identified. Furthermore, possible alternative matches may also be displayed and/or identified as well based on the relative confidence of the processor 324 and/or 330.

Once a particular model, such as model 303 is selected as being the most likely match for image 320, then data associated with image 303 (as shown in data 336) may be displayed on display 338 of Smart Phone 310 or otherwise communicated to the user. It is most likely that the data would at least identify the plant corresponding to the plant portion such as shown in FIG. 3. For some embodiments such as for nurseries, namely, the price of the plant corresponding to the plant could be displayed. Other commercial or non-commercial applications may provide this or different data to a user.

When providing the comparison step shown in FIG. 3, it is likely that certain distances or relative distances may be important such as the distance from the tip of the leaf to the base of the leaf possibly relative to the width of the leaf. It may also be that absolute distances can be calculated and/or estimated in some way such as by requiring the user take image 320 from a specific distance to the plant, such at 2 feet, etc. The application may estimate the length of the leaf which may assist in determining which plant or shrub corresponds to a particular portion, particularly if orientations are also specified. Various kind of instructions may be provided to the smartphone 310 such as what orientation the image 320 could be taken to most beneficially minimize the turning of either the image 320 or the model 303 by axes 332 and 334 for the best match, if done at all.

Various height, width and depth information can be useful particularly in relationship to other features of the plant which may be distinguishable from other plants to facilitate match with the database entries 300-308. Furthermore, it may be color is particularly helpful in identifying a particular plant distinguishable from one another which can also be calculated by the processor 324 and/or 330.

The application described herein includes various smartphones 310 such as the iPhone™, various Android™ based phones as well as Blackberry™ or other smartphone technology as available. Basically, any camera 322 connected or coupled to a processor 324 may work as utilized with a methodology shown and described herein. In addition to still images taken with the camera 322, moving images may be taken if the camera has that capability and then such images may be compared to database entries utilizing the methodology shown and described herein.

A user could also input information into the smartphone 310 to assist the process such as the likely age of the photographed image. Absolute measurements, the portion of the plant image such as leaf, flower, and/or other information, etc., may be provided as input to assist the processor(s) 324, 330. Other information may be helpful as well, such as a specific temperate region or zone where the plant is located or whether the plant is in its natural state. Such information may further assist the processor 324, 330 in making the selection. Other information may also be requested, provided and/or analyzed by the processor(s) 324, 330 in an effort to discern the type of plant being identified.

The processor(s) 324, 330 analyzes the image(s) 320 relative to the database entries 300-308 according to at least one algorithm to ascertain which of the entries 300-308 are most likely to correspond to image or images 320. As seen in FIG. 3, entry 303 is identified as the best matching candidate. The data associated with entry 303 namely data 336 has been identified and is then displayed on display 338.

Display 338 may be a portion of smartphone 310. Data 336 may otherwise be communicated through alternative computing displays. Each of the database entries 300-308 are preferably linked to data and/or information in order to include information about the type of plant being identified.

A broader classification of the target plant may be provided, i.e. broader than the actual plant corresponding to image 320. A broader classification of plant, flower, etc., may be particularly helpful. Additional ancillary data may be provided. As one example, it would useful to know that not only is the plant a blueberry bush, but a blueberry bush which tends to produce fruit in the “middle” of the season rather than late or early.

Information displayed as data 336 provided on the display 338 may also include preferred temperature, recommended planting instructions, zones, etc. Such information may be associated with GPS location to predict for example the date a certain fruit ripens and/or other information helpful to users. If the user is a nursery, pricing could be provided. In other embodiments, other information may be provided to the users as would be beneficial in other applications.

A plant identifying application which can identify between various trees, flowers, shrubs, etc., is shown and described herein.

The Plantsnap application may under an embodiment perform the following steps:

Step 1: The user of the application chooses an image either from their camera or the local memory of the device (gallery).

Step 2: The user may reframe the selected image, so that it corresponds to the guidelines of taking a “good” image.

Step 3: The image is saved locally on the device and then uploaded to Imagga's content endpoint. This endpoint returns a content id, which is then used to make a second request to its categorization endpoint for Plantsnap's categorizer. This returns a list of categories and corresponding confidence regarding accuracy of identification.

Step 4: The results are visualized in the user application, where separate requests are made for each result to api.earth.com to retrieve the images for each plant for visualization in the user interface.

Step 5: If the user wishes greater details for a given plant, a new request is made to api.earth.com for that particular plant in order to retrieve all the details available.

Step 6: The user may:

A) make a selection to accept one of the proposed results;

B) suggest a name of the plant, if it's not in the proposed results and the user knows the name;

C) send the image for identification, which saves the snap with a special status.

These images are later reviewed and saved with reviewed names, which are visualized in the user application.

Step 7: The user snap is logged in Plantsnap's proprietary database and the user image is uploaded to a bucket in Amazon AWS S3.

Note that the Plantsnap application may use a third party API such as Imagga™ API endpoints to tag and classify an image. By sending image URLs to a /tagging endpoint the application may receive a list of automatically suggested textual tags. A confidence percentage may be assigned to each of them so that the application may filter the most relevant or highest priority tag, image type.

A categorizer may then be used to recognize various objects (species). The Plantsnap platform may train categorizers or recognition engines to identify species. An auto categorization API makes it possible to conveniently train such engines. When a request to the ‘/categorizers’ endpoint is made, the API responds with a JSON array of objects each of which describing accessible categorizers. As soon as the best categorizer/classifier is identified, the image may processed for classification. This is achieved with a simple GET request to this endpoint. If the classification is successful, as a result, the application receives a list of classifications/categories, each with a confidence percentage specifying how confident the system is about the particular result.

Under an embodiment of the Plantsnap platform, the “categorizer” referenced above is updated every month using user images and curated images. Accordingly, the Plantsnap algorithm improves every month.

The application is translated into 20 languages, under an embodiment.

Under one embodiment, image analysis is conducted by one set of servers (Imagga™), and the details and results are provided by Plantsnap servers.

The Plantsnap application/platform may run on laptops, computers, and/or iPads™. The Plantsnap application/platform may run as a web-based application.

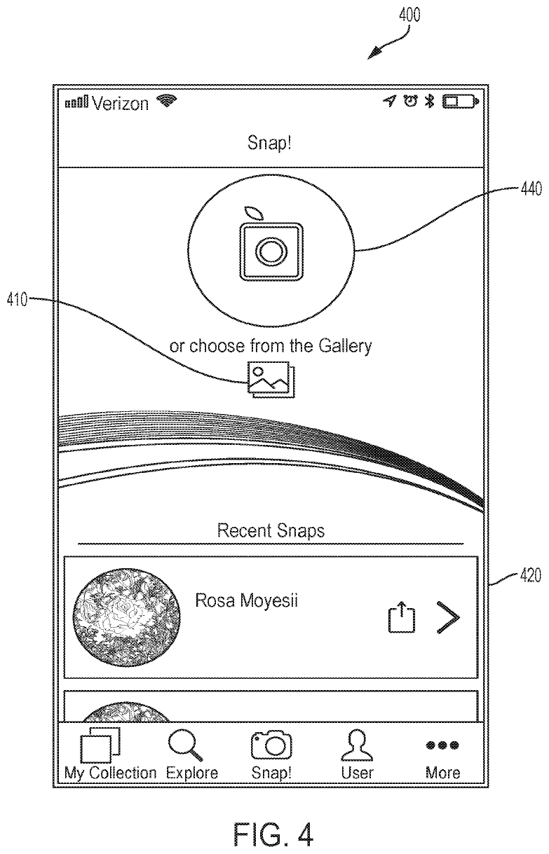

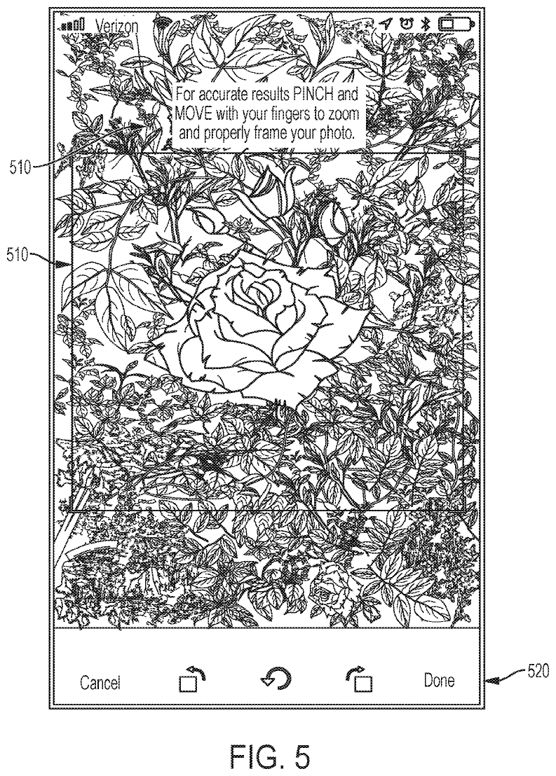

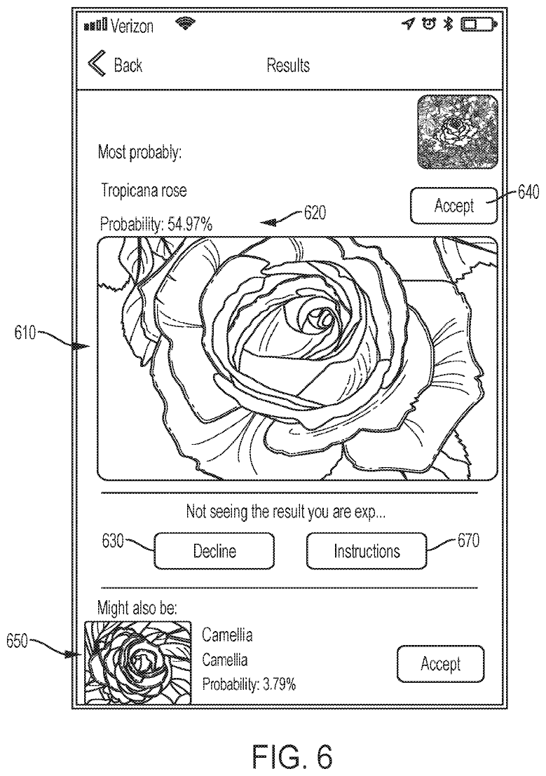

FIG. 4 shows the general snap screen 400 presented to a user when a user starts the application. The user may select a snap option 440 on the snap screen to capture an image of a flower or plant. FIG. 4 also shows recent snap shots 420 analyzed by the application and accepted by the user. Alternatively, a user may select gallery option 410 as further described below. Once a plant/flower is photographed, the application encourages the user to crop the image properly in order to highlight the plant/flower or highlight a selection of leaves. FIG. 5 shows the crop tool 510 of the application, under an embodiment. The Plantsnap application then attempts to identify the plant or flower. Under an embodiment, the application returns an image which comprises the highest likelihood of proper identification. FIG. 6 shows that the application identifies the plant 610 with a 54.97% probability 620 of proper identification. The user has the option of accepting 640 or declining 630 the identification. The use may also selection an instruction option 670 to view tutorials instructing proper use of the application's image capture tool. The application provides alternative identifications with corresponding probabilities. Under an embodiment, a user may swipe right to scroll through alternative identifications with a similar option of accepting or declining the identification. Additional potential identifications are presented in a selection wheel 650 of the screen. The user may use this selection wheel to find and accept an alternative plant identification.

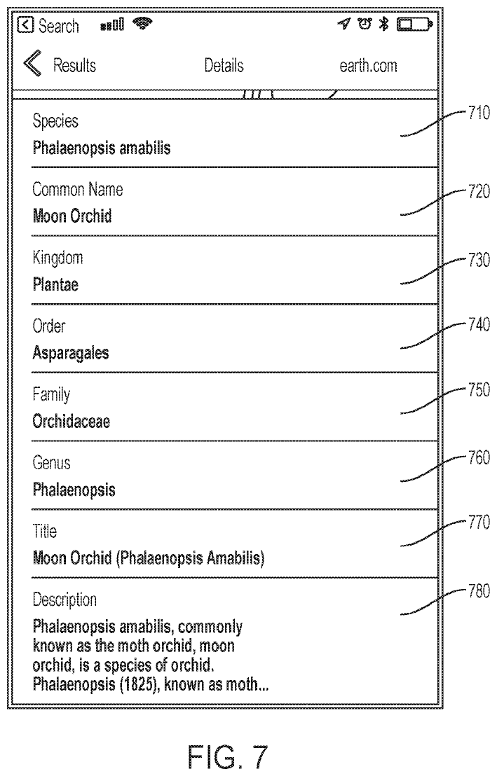

A user may at any time select a plant/flower image. Selection of an image clicks through to a detailed description of the plant/image as seen in FIG. 7. The screen of FIG. 7 shows Species 710, Common Name 720, Kingdom 730, Order 740, Family 750, Genus 760, Title 770, and Description 780 of the plant/flower.

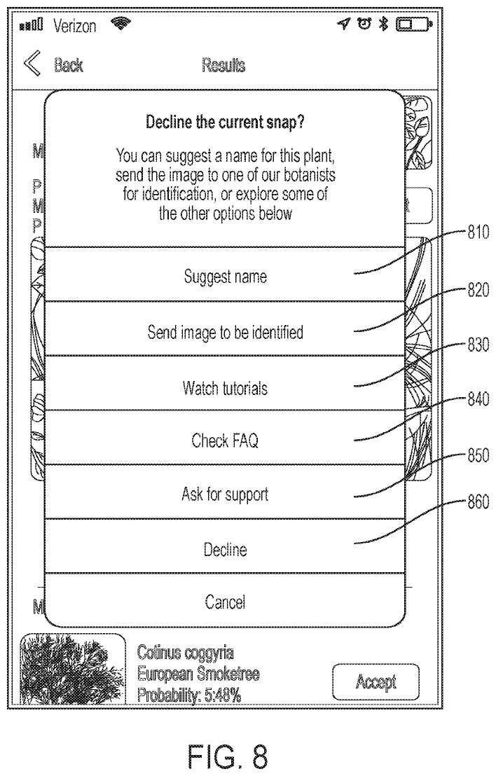

Selection of the decline option (as seen in FIG. 6) passes the user to the screen of FIG. 8. The user may then suggest a name 810, send the image to be identified 820, watch tutorials 830 for instruction in optimizing accuracy of the application's identification process. The user may select Check FAQ 840 to review frequently asked questions. The user may ask for support 850 and send an email to Plantsnap representatives requesting further assistance or instruction. The user may simply decline 860 the current application identification.

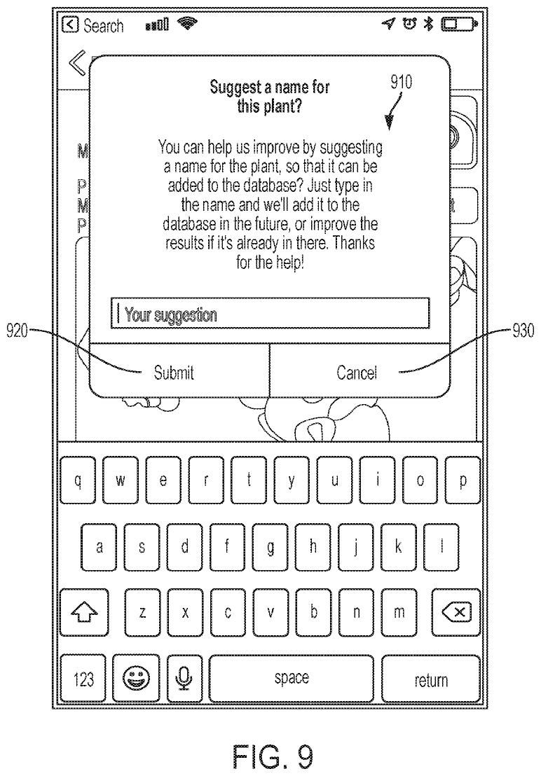

If the user selects the suggest a name option 810, the user is presented with the screen of FIG. 9. The screen prompts the user to suggest a name 910 for the plant/flower. The application requests entry of the name so that it may be added to the Plantsnap database. The screen states: “You can help us improve by suggesting a name for the plant, so that it can be added to the database. Just type in the name and we'll add it to the database in the future, or improve the results if its already in there. Thanks for the help!”. The user may submit a name 920 or cancel the screen 930.

The user may either snap an image for identification or retrieve a photograph from a photo gallery for identification (see FIG. 4). Once an image is selected from gallery, the application directs a user through the same workflow described above, under an embodiment.

Under an embodiment, the Plantsnap application logs both snapshots that are saved by the user as well as snapshots that are declined (along with corresponding probability of successful identification). Under an embodiment, the Plantsnap application saves proposed results along with the image captured by the user to enable proper analysis of proper versus improper categorizations.

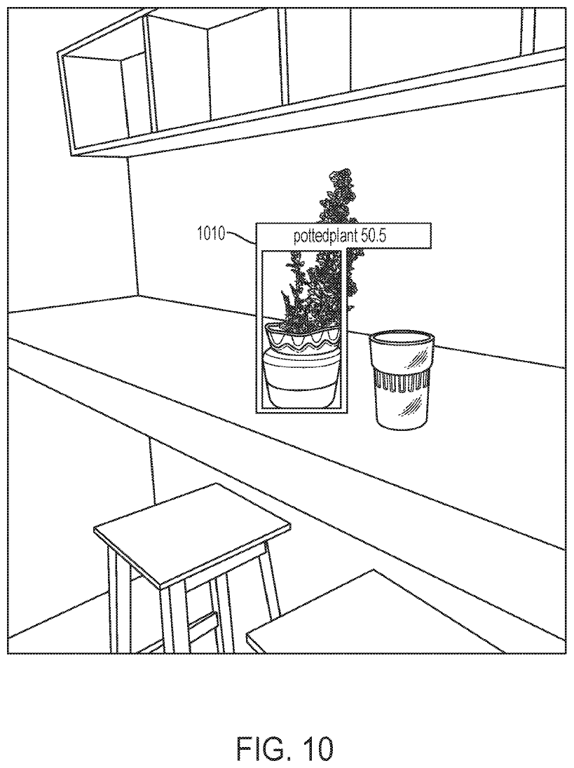

An embodiment of the applicant may integrate an object detection model. As one example, an applicant running iOS™ may use Apple's™ new machine learning API CoreML released along with iOS11 in the Fall of 2017. Using on-device capabilities, the application is able under an embodiment to detect parts of an image containing a plant and use only those part(s) of the image for performing a categorization. FIG. 10 shows operation of the object detection model including an identified section of the image 1010 comprising a plant. If the model cannot find any potential plants for recognition or if the model incorrectly identifies a portion of an image that is not a plant, then the application may allow the user to select the part of the image subject to recognition.

Under one embodiment, an image recognition model is stored locally and performs the recognition directly on the device. This approach eliminates the need to perform an upload to Imagga's content endpoint and then make a separate request for the categorization. Plant details are under an embodiment retrieved from api.earth.com. A record of the user's snapshot is captured whenever there is an internet connection available. This strategy reduces the time-to-result on high end iOS devices, under an embodiment.

A backend of the Plantsnap application may provide an Application Programming Interface (API), which allows under one embodiment third-parties like Plantsnap's partners to use the technology by uploading an image file comprising a plant and receiving results for the plant's probable name and all other corresponding plant details for each result. The API may also function to make a record of every image any user takes with a user's camera or selects from a user's mobile device photo gallery for analysis, along with the identification categories that have been proposed by the image recognition. In other words, the API may function to make a record of every image a user submits for analysis together with an analysis results (whether the user declines the results or not). This approach provides for a much deeper and more exhaustive analysis of why a user declines an image and provides an ability to give users feedback and improve end user experience. The API may comprise one or more applications running on at least one processor of a mobile device or one or more servers remote to the application.

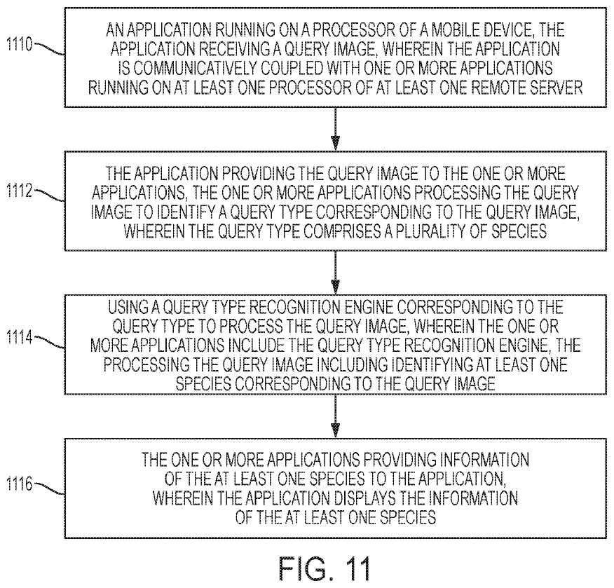

FIG. 11 shows a system for processing an image comprising 1100 an application running on a processor of a mobile device, the application receiving a query image, wherein the application is communicatively coupled with one or more applications running on at least one processor of at least one remote server. The system includes 1112 the application providing the query image to the one or more applications, the one or more applications processing the query image to identify a query type corresponding to the query image, wherein the query type comprises a plurality of species. The system includes 1114 using a query type recognition engine corresponding to the query type to process the query image, wherein the one or more applications include the query type recognition engine, the processing the query image including identifying at least one species corresponding to the query image. The system includes 1116 the one or more applications providing information of the at least one species to the application, wherein the application displays the information of the at least one species. The Plantsnap application may allow users to earn snapshots or snaps.

The Plantsnap platform may implement the concept of leaderboards. A user may earn snap points for snaps. Each saved or taken snap earns a point. The concept may require the following backend requirements:

API endpoints for adding, retrieving total amount of user points, weekly amount of user points, daily amount of user points.

API endpoint for checking points daily, weekly, monthly, overall.

API endpoint for rewarding the daily, weekly, monthly leader with extra points and also sending the leader a notification that the user has won.

The concept may require the following frontend requirements:

Show points gathered when taking a snap. Call to backend to update points.

Show total points and leaderboards in a user tab. Call to backend for retrieving data.

The Plantsnap platform may provide daily “login” bonuses that are later convertible to free snaps when under the freemium model as further described below. A user may receive a bonus for every day the application is open and used to take a snap. A notification may be provided to the user to remind the user to open the application and receive the bonus. The concept may require the following backend requirements:

Logic for gathering the bonuses (Day 1-50 pts, Day 2-150 pts, etc . . . ).

API endpoints for checking daily user “login” status.

API endpoint for saving user bonus points.

API endpoint for retrieving user bonus points.

API endpoint for converting user bonus points to rewards (free snaps, or something else).

The concept may require the following frontend requirements:

A proper way to visualize the daily bonus collection when opening the application for the first time that day. When points are to be gathered, call to backend to check user's daily bonus status and for kind of bonus user is eligible to receive. Once a day is missed, a user starts from Day 1 again.

Showing gathered bonus points in user tab. Call to backend to retrieve bonus points.

Proper way for converting bonus points into rewards. Call to backend to validate the conversion.

The Plantsnap platform may award users skill points based on quiz results, i.e. answers to multiple choice questions selected from 4 possible plant answers. General Quizzes for guessing plants may be accessible from a section inside the application. The application may handle quizzes locally on the devices for a number of quizzes. Alternatively, the quizzes may be handled server side. Under this embodiment, a section in an application dashboard may be used define and save the quizzes, so that the quizzes may be later retrieved on the devices. The Plantsnap platform may provide inline quizzes for guessing the plant which was just snapped. This feature may be provided on an opt-in basis, so that users who don't want to participate may avoid the feature. The quiz feature described above needs backend support for showing relevant multiple choice options. An embodiment may use Imagga,s™ new similar search feature to look for similar plants to make quizzes challenging.

The Plantsnap platform may provide scrabble and Guess-the-word kind of experiences.

The Plantsnap platform may provide a Plantsnap Freemium experience/service. Users may receive a few snaps for free upon initial download/use of the application. The application may use a simple counter to track snaps saved. The counter is alternatively implemented on the backend of the Plantsnap platform. When a user downloads the application an anonymous user is created in Firebase™ and the appropriate amount of snap credits are added. If they choose to register, the credits are transferred to the registered user.

The concept described above may require the following backend requirements:

Handle adding, subtracting and retrieving user credits.

Handle merging of users from Anonymous to Registered status and transferring snaps.

The concept described above may require the following frontend requirements:

Provide a clear representation upon saving a snap that the user has a limited amount of credits left and has used “x out of y” credits. Call to API every time a user is about to use a credit to check availability and subtract when a credit has been used.

Present an offer for subscription when credits are depleted.

Block the camera/gallery experience once credits are depleted and no valid subscription exits.

The Plantsnap platform may provide a free snap credit for watching an ad served through Firebase™ under an embodiment. The concept may require the following backend requirements:

Call to API for adding a snap credit when watching an ad.

Call to API to retrieve the credit and use inside the application.

The concept may require the following frontend requirements:

Show the option when the user has run out of credits after the user is presented with the offer to buy a subscription.

Present the ad.

Call to API to add the credit.

Call to API to subtract the credit after credit been used.

There are two ways to subscribe to the Plantsnap platform. Either a user shares a subscription for a user account across platforms (iOS™, Android™) or purchases a platform specific subscription. A Monthly subscription may be available for $3.99. A yearly subscription may be available for $39.99. Under an alternative embodiment, a user may buy snap credits—buy 3 snaps for $0.99 and 10 snaps for $2.99

The subscription service may comprise the following backend requirements:

API support for adding a subscription once purchased.

API support for cancelling a subscription when cancelled.

API support for subscription upgrade/downgrades.

API support for periodically checking if a subscription is still valid or has been cancelled.

The subscription service may comprise the following frontend requirements:

Periodically check if subscription is still valid or has been cancelled and make necessary calls to the API to update.

Present the offers to the users in a clear and understandable way.

Block the recognition part of the application if there is no subscription or credits left.

Unblock the recognition part of the application if there is a valid subscription.

Note that one or more of the features of the Plantsnap platform may be implemented using Firebase™ mobile application services. Under an embodiment, the Firebase™ platform is used to manage the registration and credit/point system described above.

A system is described herein that comprises under one embodiment an application running on a processor of a mobile device, the application receiving a query image, wherein the application is communicatively coupled with one or more applications running on at least one processor of at least one remote server. The system includes the application providing the query image to the one or more applications, the one or more applications processing the query image to identify a query type corresponding to the query image, wherein the query type comprises a plurality of species. The system includes using a query type recognition engine corresponding to the query type to process the query image, wherein the one or more applications include the query type recognition engine, the processing the query image including identifying at least one species corresponding to the query image. The system includes the one or more applications providing information of the at least one species to the application, wherein the application displays the information of the at least one species.

The providing the information includes providing a level of confidence for each species of the at least one species, under an embodiment.

The query type of an embodiment comprises one or more of a leaf, a flower, a whole plant, and grass.

The system of an embodiment comprises providing training images to the one or more applications for each combination of query type and species of the plurality of species.

The one or more applications of an embodiment use the training images to train the query type recognition engine, the training the query type recognition engine comprising defining attributes for each combination of query type and species of the plurality of species.

The query type recognition engine of an embodiment uses information of the attributes to identify the at least one species.

The providing the training images comprises under an embodiment curating the training images from at least one database.

The at least one database of an embodiment includes a United States Department of Agriculture (USDA) database and an Encyclopedia of Life™ database.

The providing the training images comprises under an embodiment curating the training images through image searching using one or more image search engines.

The one or more image search engines of an embodiment include Google™ and flickr™.

The providing the training images comprises under an embodiment augmenting the training images, the augmenting comprising producing additional images derived from at least one image of the training images.

The producing the additional images includes under an embodiment one or more of rotating the at least one image, cropping the at least one image, manipulating the at least one image to simulate variable camera angles, segmenting the at least one image, and superimposing the at least one image on at least one different background.

The receiving the query image comprises under an embodiment receiving the query image through operation of a camera of the mobile device.

The receiving the query image includes under an embodiment receiving a GPS location of the mobile device at the moment the mobile device camera captures the query image.

The application of an embodiment receives a request for additional information regarding the at least one species.

The application of an embodiment requests the additional information from api.earth.com.

The additional information of an embodiment comprises at least one of species, common name, kingdom, order, family, genus, title, and description.

The application of an embodiment receives a refusal to accept an identification of the at least one species, the application receiving a suggested identification of the at least one species.

A system is described herein that comprises an application running on a processor of a mobile device, the application receiving a query image, wherein the application is communicatively coupled with one or more applications running on at least one processor of at least one remote server. The system includes the application providing the query image to the one or more applications, the one or more applications processing the query image to identify a query type corresponding to the query image, wherein the query type comprises a plurality of species. The system includes using a query type recognition engine corresponding to the query type to process the query image, wherein the one or more applications include the query type recognition engine, the processing the query image including identifying at least one species corresponding to the query image. The system includes providing training images to the one or more applications for each combination of query type and species of the plurality of species to train the query type recognition engine in identifying the at least one species. The system includes the one or more applications providing information of the at least one species to the application, wherein the application displays the information of the at least one species.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The systems and methods for electronically identifying plant species can be a component of a single system, multiple systems, and/or geographically separate systems. The systems and methods for electronically identifying plant species can also be a subcomponent or subsystem of a single system, multiple systems, and/or geographically separate systems. The components of systems and methods for electronically identifying plant species can be coupled to one or more other components (not shown) of a host system or a system coupled to the host system.

One or more components of the systems and methods for electronically identifying plant species and/or a corresponding interface, system or application to which the systems and methods for electronically identifying plant species is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the systems and methods for electronically identifying plant species can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems and methods for electronically identifying plant species and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods for electronically identifying plant species and corresponding systems and methods include: microcontrollers with memory (such as electronically erasable programmable read only memory (EEPROM)), embedded microprocessors, firmware, software, etc. Furthermore, aspects of the systems and methods for electronically identifying plant species and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods for electronically identifying plant species is not intended to be exhaustive or to limit the systems and methods to the precise forms disclosed. While specific embodiments of, and examples for, the systems and methods for electronically identifying plant species and corresponding systems and methods are described herein for illustrative purposes, various equivalent modifications are possible within the scope of the systems and methods, as those skilled in the relevant art will recognize. The teachings of the systems and methods for electronically identifying plant species and corresponding systems and methods provided herein can be applied to other systems and methods, not only for the systems and methods described above.

The elements and acts of the various embodiments described above can be combined to provide further embodiments. These and other changes can be made to the systems and methods for electronically identifying plant species and corresponding systems and methods in light of the above detailed description.

1. A system comprising,
an application running on a processor of a mobile device, the application receiving a query image, wherein the application is communicatively coupled with one or more applications running on at least one processor of at least one remote server;
the application providing the query image to the one or more applications, the one or more applications analyzing the query image to identify a query type corresponding to the query image, wherein the query type comprises a plurality of species;
providing training images to the one or more applications for each combination of query type and species of the plurality of species to train a query type recognition engine in identifying the plurality of species, wherein the providing the training images comprises curating the training images from a at least on publicly available database and curating the training images through image searching using one or more image search engines, wherein the one or more applications include the query type recognition engine,
the one or more applications using the query type recognition engine corresponding to the query type to process the query image, the processing the query image including identifying at least one species corresponding to the query image;
the one or more applications providing information of the at least one species to the application, wherein the application displays the information of the at least one species.

2. The system of claim 1, wherein the providing the information includes providing a level of confidence for each species of the at least one species.

3. The system of claim 1, wherein the query type comprises one or more of a leaf, a flower, a whole plant, and grass.

4. (canceled)

5. The system of claim 1, wherein the training the query type recognition engine comprises defining attributes for each combination of query type and species of the plurality of species.

6. The system of claim 5, the processing the query image comprising using information of the attributes to identify the at least one species.

7-10. (canceled)

11. The system of claim 1, wherein the providing the training images comprises augmenting the training images, the augmenting comprising producing additional images derived from at least one image of the training images.

12. The system of claim 11, the producing the additional images including one or more of rotating the at least one image, cropping the at least one image, manipulating the at least one image to simulate variable camera angles, segmenting the at least one image, and superimposing the at least one image on at least one different background.

13. The system of claim 1, the receiving the query image comprising receiving the query image through operation of a camera of the mobile device.

14. The system of claim 13, the receiving the query image including receiving a GPS location of the mobile device at the moment the mobile device camera captures the query image.

15. The system of claim 1, comprising the application receiving a request for additional information regarding the at least one species.

16. The system of claim 15, comprising the application requesting the additional information from a remote information server.

17. The system of claim 16, wherein the additional information comprises at least one of species, common name, kingdom, order, family, genus, title, and description.

18. The system of claim 1, comprising the application receiving a refusal to accept an identification of the at least one species, the application receiving a suggested identification of the at least one species.

19. A system comprising, an application running on a processor of a mobile device, the application receiving a query image, wherein the application is communicatively coupled with one or more applications running on at least one processor of at least one remote server;
the application providing the query image to the one or more applications, the one or more applications analyzing the query image to identify a query type corresponding to the query image, wherein the query type comprises a plurality of species;
providing training images to the one or more applications for each combination of query type and species of the plurality of species to train a query type recognition engine in identifying the plurality of species, wherein the providing the training images comprises curating the training images from at least one publicly available database and curating the training images through image searching using one or more image search engines, wherein the one or more applications include the query type recognition engine;
using query type recognition engine corresponding to the query type to process the query image, the processing the query image including identifying at least one species corresponding to the query image;
providing training images to the one or more applications for each combination of query type and species of the plurality of species to train the query type recognition engine in identifying the at least one species.
